(19) United States
(12) Patent Application Publication
(10) Pub. No.: US 2017/0240344 A1
(43) Pub. Date: Aug. 24, 2017

(54) FUEL CANISTERS AND FUEL CANISTER VALVE ASSEMBLIES

(71) Applicant: Sympafix BV, Alkmaar (NL)

(72) Inventor: Paul Geuvers, Alkmaar (NL)

(21) Appl. No.: 15/437,120

(22) Filed: Feb. 20, 2017

(30) Foreign Application Priority Data
Feb. 21, 2016 (GB) 1602985.2

(51) Int. Cl. B65D 83/42; B25C 1/08; B65D 83/14; B65D 83/48; B65D 83/62

(52) U.S. Cl. CPC B65D 83/425; B65D 83/48; B65D 83/62; B65D 83/752; B25C 1/08

(57) ABSTRACT

A fuel canister valve assembly has a valve cup, a valve stem housing connected with the valve cup and defining a seal housing containing a valve seal and a valve stem having an inner end housed in the valve stem housing and extending through the valve seal to an outer end disposed externally of the valve stem housing. The valve stem housing has an outer periphery provided with at least one side passage defining a flow path along the outer periphery.

### CROSS REFERENCE TO RELATED APPLICATION

This application claims the benefit of United Kingdom patent application No. 1602985.2 filed Feb. 21, 2016, which is hereby incorporated by reference.

### FIELD OF THE INVENTION

The invention relates to fuel canisters and fuel canister valve assemblies.

### BACKGROUND TO THE INVENTION

It is known to provide fastener driving tools with a striking mechanism that is operable to apply an impact to a fastener to drive the fastener into a substrate. Such fastener driving tools are sometimes referred to as nailers or nail guns. Some fastener driving tools generate the force that drives the striking mechanism by combusting a fuel gas. The fuel may be supplied from a fuel canister that when empty is removed from the fastener driving tool to allow fitting of a replacement fuel canister.

A fastener driving tool fuel canister may comprise an outer container, an inner container housed in the outer container and a valve assembly secured to both the inner and outer container. The inner container is a flexible body that contains the fuel and the space defined between the inner and outer containers contains a propellant that applies an external pressure to the inner container. The valve assembly comprises a valve that when depressed allows fuel to flow from the inner container urged by the pressure applied by the propellant. Usually, the valve is depressed automatically when the fuel canister is loaded into the fastener driving tool and the flow of fuel from the fuel canister is controlled by a valve in the tool.

Fuel canisters may be filled by so-called under-cup pressurization or by through the valve pressurization. Under-cup pressurization entails fitting an inner container attached to a valve assembly into an outer container and then injecting liquefied propellant into the outer container prior to securing the valve assembly to the outer container. Liquefied fuel is then injected into the inner container through the valve. Through the valve pressurization entails fitting and securing an inner container attached to a valve assembly into an outer container so as to seal the spaced defined between the inner and outer containers and then injecting a liquid propellant through the valve into the space between the inner and outer containers. Subsequently, fuel is injected into the inner container through the valve.

### SUMMARY OF THE INVENTION

The invention provides a fuel canister valve assembly comprising:

a valve cup;

a valve stem housing connected with said valve cup and defining a seal housing having a first sealing surface and at least one second sealing surface extending transversely with respect to said first sealing surface;

a valve seal disposed in said seal housing and having a first sealing surface and a second sealing surface respectively engaging said first and second sealing surfaces of said seal housing; and a valve stem having an inner end housed in said valve stem housing and extending through said valve seal to an outer end disposed externally of said valve stem housing, wherein said valve stem housing has an outer periphery provided with at least one side passage defining a flow path along said outer periphery.

The invention also includes a fuel canister valve assembly comprising:
an outer container;
an inner container; and
a valve assembly,
wherein said valve assembly comprises:
   a valve cup;
   a valve stem housing connected with said valve cup and defining a seal housing having a first sealing surface and at least one second sealing surface extending transversely with respect to said first sealing surface;
   a valve seal disposed in said seal housing and having a first sealing surface and a second sealing surface respectively engaging said first and second sealing surfaces of said seal housing; and
   a valve stem having an inner end housed in said valve stem housing and extending through said valve seal to an outer end disposed externally of said valve stem housing,
   wherein said valve stem housing has an outer periphery provided with at least one side passage defining a flow path along said outer periphery.

The invention also includes a fuel canister comprising:
an outer container;
an inner container; and
a valve assembly to control release of a fuel from said inner container,
wherein said valve assembly comprises:
   a valve cup;
   a valve stem housing connected with said valve cup; and
   a valve stem having an inner end housed in said valve stem housing and an outer end disposed externally of said valve stem housing, said valve stem movable inwardly of said valve stem housing to release said fuel,
   wherein said valve cup is secured to said valve stem housing by a plurality of protrusions provided on said valve cup that engage said valve stem housing,
   wherein said valve stem housing has an outer periphery provided with at least one side passage defining a flow path along said outer periphery,
   wherein said valve stem housing has a first end and said at least one side passage has an upstream end disposed at, or a first distance from, said first end and a downstream end disposed a second distance from said first end that is greater than said first distance; and
   wherein said protrusions grip said outer periphery at one or more locations intermediate and spaced from said upstream and downstream ends of said at least one side passage.

The invention also includes a method of filling a fuel canister that comprises an outer container, an inner container disposed in said outer container and a valve assembly secured to said inner and outer containers to control release of a fuel held in said inner container, wherein:
said valve assembly comprises a valve stem housing secured to a valve cup by protrusions on an inner side of said valve cup engaging said valve stem housing and a valve stem movable inwardly of said valve stem housing to release said fuel from said inner container; and
and said method comprises injecting liquefied propellant between said valve stem and said valve cup and channeling said injected liquefied propellant to a space defined between said inner and outer containers via a plurality of side passages provided in said valve stem housing.

### BRIEF DESCRIPTION OF THE DRAWINGS

In order that the invention may be well understood, some examples thereof will now be described with reference to the drawings in which:

FIG. 1 shows a partially disassembled fuel canister comprising an outer container, an inner container and a valve assembly;

FIG. 2 is a schematic sectioned view of the valve assembly;

FIG. 3 is an exploded schematic part sectioned view of a valve stem housing and valve seal of the valve assembly of FIG. 2;

FIG. 4 is a schematic plan view of the valve stem housing;

FIG. 5 is a partial schematic view of the underside of a valve cup of the valve assembly of FIG. 2;

FIG. 6 is a partially sectioned view of the fuel canister illustrating filling with liquefied propellant;

FIG. 7 is a view corresponding to FIG. 6 showing filling with liquefied fuel;

FIG. 8 is a schematic part sectioned view of another valve stem housing;

FIG. 9 is a schematic part sectioned view of yet another valve stem housing;

FIG. 10 is a view corresponding to FIG. 2 showing a modified valve assembly;

FIG. 11 is a schematic representation of another valve assembly with an attached inner container;

FIG. 12 is a perspective view of a valve stem housing of the valve assembly of FIG. 11;

FIG. 13 is a perspective view of another valve stem housing for the valve assembly of FIG. 11;

FIG. 14 is view corresponding to FIG. 11 showing yet another modified valve stem housing; and

FIG. 15 is a view corresponding to FIG. 11 showing still another modified valve stem housing.

### DETAILED DESCRIPTION

For the purpose of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates. One embodiment of the invention is shown in great detail, although it will be apparent to those skilled in the relevant art that some features that are not relevant to the present invention may not be shown for the sake of clarity.

In the description that follows, references to ‘top’, ‘bottom’, ‘underside’, ‘upper’, ‘lower’, ‘inner, ‘outer’ and the like are to the orientation of parts shown in the drawings and since the orientation of the parts may vary when in use, they are not to be taken as limiting. Also in order to better illustrate the examples, the features shown in the drawings may not be in proportion.

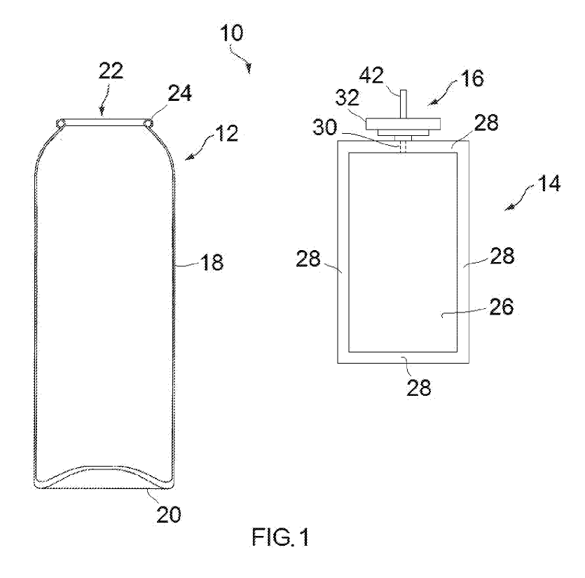

Referring to FIG. 1, a fuel canister 10 comprises an outer container 12, an inner container 14 and a valve assembly 16. The inner container 14 may be secured to the valve assembly 16 prior to insertion into the outer container 12.

The outer container 12 is an elongate body comprising a side wall 18 and a bottom wall 20 disposed at a first end of the side wall. The bottom wall 20 may arch inwardly to provide the outer container with additional body strength. The second end of the side wall 18 defines a valve opening 22 and has a beaded, or rolled, edge 24 to provide a strong seat to which the valve assembly may be secured. The outer container 12 may have an at least substantially circular cross section and may be a metal body. For example, the outer container 12 may be an aluminum or aluminum alloy body that is formed by indirect, or backwards, extrusion followed by one or more forming operations to shape the bottom wall 20 and the beaded edge 24. In the illustrated example, the side wall 18 curves inwardly adjacent the valve opening 22. It is to be understood that this is not essential and that the side wall 18 may be at least substantially straight and that in at least some examples, the outside diameter of the outer container 12 between the bottom wall 20 and the beaded edge 24 may be at least substantially constant.

The inner container 14 may be a collapsible bag made of a flexible material such as a plastics material, metal foil or the like that is impervious to the both the fuel and the propellant. The inner container 14 may be formed by disposing the two generally rectangular sides 26 (only one of which is visible in the drawing) in face to face relation and bonding, or sealing, them together around their respective peripheries 28 to define an interior space to contain a fuel. The inner container 14 is provided with an opening 30 at the upper end for fitting to the valve assembly 16.

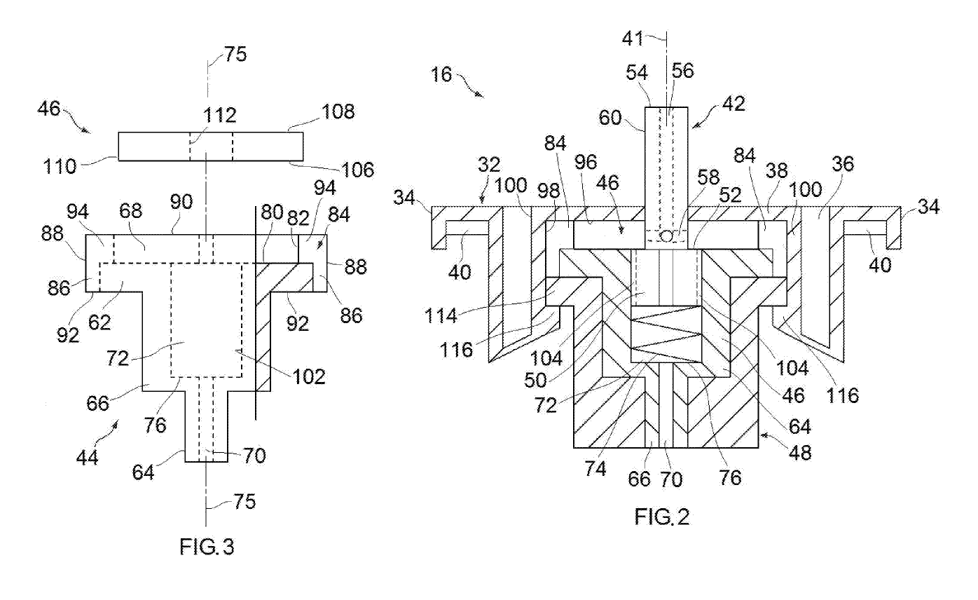

Referring to FIG. 2, the valve assembly 16 comprises a valve cup 32, which may be made of metal. The valve cup 32 is configured to fit over the valve opening 22 and be sealingly secured to the beaded edge 24 so as to provide a sealed space between the inner and outer containers 12, 14 to contain a propellant. The valve cup 32 may comprise a dished body that defines a rim 34 configured to fit over the beaded edge 24 and a central depression 36 containing a boss 38 that projects upwardly from the base of the depression. The underside of the rim 34 defines a circumferentially extending groove in which an annular sealing member 40 is housed. The annular sealing member 40 may be an annular body such as a washer made of a suitable elastomer. The arrangement is such that when the rim 34 is fitted over the beaded edge 24, the sealing member 40 is sandwiched between the beaded edge and the rim. The valve cup 32 may be secured to the outer container 12 by crimping the rim 34 onto the beaded edge 24. This may compress the sealing member 40 to ensure that the interface between the valve assembly 16 and outer container 12 is sealed.

Referring to FIGS. 2 and 3, the valve assembly 16 may further comprise a valve stem 42, a valve stem housing 44, a valve seal 46 and an inner container mounting member 48.

The inner containing mounting member 48 is not essential as in some examples, the inner container 14 may be mounted directly to the valve stem housing 44.

Referring to FIG. 2, the valve stem 42 is an elongate body provided with an enlarged inner end, or base, 50. The valve stem 42 may be a generally cylindrical body. The valve stem base 50 defines an annular surface 52 extending transversely with respect to the longitudinal axis 41 of the valve stem 42. The annular surface 52 faces the valve seal 46 and an outer end, or tip, 54 of the valve stem 42. The valve stem 42 defines an axially extending delivery passage 56 that extends from the tip 54 to a position adjacent the annular surface 52 and at least one side passage 58 extending between the inner end of the delivery passage 56 and an outer peripheral surface, or side wall, 60 of the valve stem. Although not essential, in the illustrated example there are four side passages 58 disposed in a common plane and spaced 90° degrees apart. The or each side passage 58 and the annular surface 52 may be disposed at least substantially perpendicular to the longitudinal axis of the valve stem 42.

Referring to FIGS. 2 and 3, the valve stem housing 44 may be a stepped generally cylindrical body that comprises a relatively larger diameter outer end portion 62, a relatively smaller diameter inner end portion 64 and a relatively intermediate diameter central portion 66 extending between the inner and outer end portions. The outer end portion 62 defines a seal housing 68 to contain the valve seal 46. The seal housing 68 may take the form of a circular recess defined in the free end of the outer end portion 62. The inner end portion 64 defines an axially extending delivery passage 70. The central portion 66 defines a space, or chamber, 72 to contain the valve stem base 50 and a biasing member 74. The biasing member 74 is positioned between the underside of the valve stem base 50 and an annular biasing surface 76 defined by the change in diameter between the delivery passage 70 and the chamber 72 and is configured to bias the valve stem 42 to a valve closed condition in which the radially outer end of the or each side passage 58 is covered by the valve seal 46. A valve open condition is obtained by depressing the valve stem 42 against the biasing force of the biasing member 74 by applying an axially directed force to the tip 54 to move the or each side passage 58 into the chamber 72 to allow fluid flow from the delivery passage 56 to the chamber 72 during filling via the or each side passage. In use of the fuel canister 10, depressing the valve stem 42 allows fluid flow from the inner container 14 to the delivery passage 56 via the delivery passage 70, chamber 72 and side passages 58. The biasing member 74 may comprise any suitable resilient member such as, for example, a compression spring.

Still referring to FIG. 3, the seal housing 68 is disposed at the outer end of the valve stem housing 44 and defines a first sealing surface 80 that extends transverse to the longitudinal axis of the valve stem housing and one or more second sealing surfaces 82 that extend around the circumference of, and transverse to, the first sealing surface. The first sealing surface 80 may be disposed at least substantially perpendicular to the longitudinal axis 75 of the valve stem housing 44. The or each second sealing surface 82 may be disposed at least substantially perpendicular to the first sealing surface 80.

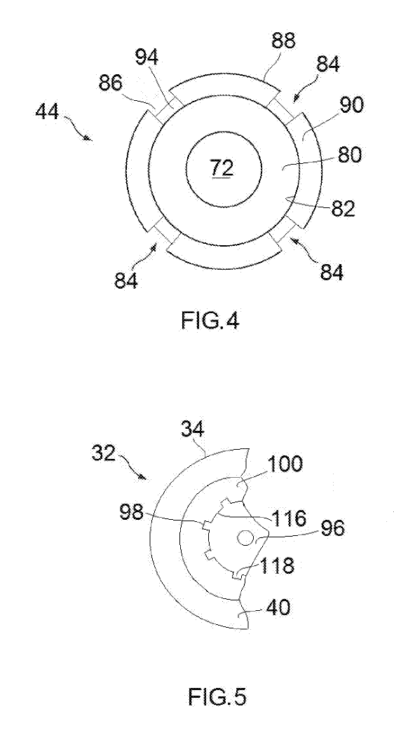

Referring to FIGS. 3 and 4, the valve stem housing 44 may be provided with one or more side passages 84. The or each side passage 84 comprises a first portion 86 extending along the outer periphery of the valve stem housing 44 as defined by an outer peripheral surface 88 of the outer end portion 62. The first portion 86 of the side passage 84 may extend downwardly from the upper end of the outer end portion 62 to its lower end. The first portion 86 may comprise an open groove or channel. The or each side passage 84 may additionally comprise a second portion 94 extending radially outwardly from the seal housing 68 to the first portion 86. Referring additionally to FIG. 2, when the valve stem housing 44 is installed into the valve cup 32, the upper end 90 of the outer end portion 62 engages the underside 96 of the top face of the boss 38 and the outer peripheral surface 88 engages the inner side 98 of the side face 100 of the boss 38. The side passages 84 define respective flow paths between the seal housing 68 and the lower end 92 of the outer end portion 62 of the valve stem housing 44.

Referring to FIGS. 2 and 3, the valve stem base 50 has an outer diameter substantially equal to that of the inner wall 102 of the chamber 72 so that the valve stem 42 is guided by the inner wall 102 when moving between valve open and valve closed conditions. To assist the flow of the fuel past the valve stem base 50 when the valve stem 42 is in a valve open condition, the valve stem base may be provided with one or more lengthways extending side passages 104. The side passage or each passage 104 may take the form of an open channel extending from the underside of the valve stem base 50 to the annular surface 52. The or each passage 104 may extend at least substantially parallel to the longitudinal axis 41 of the valve stem 42.

Referring to FIG. 3, the valve seal 46 may be an annular body made of a suitable resilient material such as an elastomer. The valve seal 46 has a first sealing surface 106, a second sealing surface 108, a third sealing surface 110 and a fourth sealing surface 112. The first and third sealing surfaces 106, 108 are defined by opposed major surfaces of the valve seal 46 that may be disposed in parallel spaced apart relation. The second sealing surface 110 is defined by a circumferentially extending sidewall of the valve seal 46 that extends between and transverse to the first and third sealing surfaces 106, 108. The fourth sealing surface 112 defines a through hole extending between the first and second sealing surfaces 106, 108 and is configured to receive the valve stem 42 such that it can sealingly cover the radially outermost ends of the side passages 58, but allow relative sliding movement of the valve stem as it moves between valve open and valve closed conditions.

Referring to FIGS. 2 and 3, when installed in the valve assembly 16, the first sealing surface 106 engages the first sealing surface 80 of the seal housing 68 and the annular surface 52 of the valve stem base 50 and the third sealing surface 108 sealingly engages the underside 96 of the top face of the boss 38, while the second sealing surface 110 sealingly engages the or each second sealing surface 82 of the seal housing. The valve seal 46 typically has a thickness slightly greater than the depth of the seal housing 68 so that it is compressed between the first sealing surface 68 and the underside 96 of the top face of the boss 38.

Referring to FIG. 2, the inner container mounting member 48 is a cylindrical body that fits around the valve stem housing 44. The inner container mounting member 48 has a flange 114 at its upper end and defines a through hole configured to receive the central and inner end portions 64, 66 of the valve stem housing 44 with the underside 90 of the outer end portion 62 seated on the upper side of the flange 114. The two parts may be configured such that the central and inner end portions 64, 66 of the valve stem housing 44 are a light interference fit in the inner container mounting member 48. Alternatively, the two parts may be secured to one another by means of an adhesive or the like. The lower end of the inner container mounting member 48 is received in the opening 30 of the inner container 14, which may be sealingly secured to the inner container mounting member by a heat bonding process or a suitable adhesive. Prior to installation of the inner container 14 in the outer container 12, the inner container may be secured in a folded condition by means of frangible tapes to facilitate insertion through the valve opening 22. During filling of the inner container 14, the frangible tapes break due to the pressure exerted by the fuel so that the inner container can expand to its full size once inserted into the outer container 12.

Referring to FIGS. 2 and 5, the valve stem housing 44 and inner container mounting member 48 may be secured to the valve cup 32 by crimping the lower end of the side face 100 of the boss 38 so as to form a series of radially inwardly extending protrusions 116 that engage the inner container mounting member 48, which has been omitted from FIG. 5 for ease of representation. The protrusions 116 engage the underside of the flange 114 so that the valve stem housing 44 and inner container mounting 48 are trapped between the protrusions 116 and the underside 96 of the top side of the boss 38 and the valve seal 46 seals between the boss and the valve stem housing 44. Alternatively, the protrusions 116 may just engage the outer peripheral surface of the flange 114. The respective spaces 118 defined between adjacent protrusions 116 and gaps between the inner side 98 of the side face 100 of the boss 38 and the flange 114 function as delivery passages for the liquefied propellant during filling.

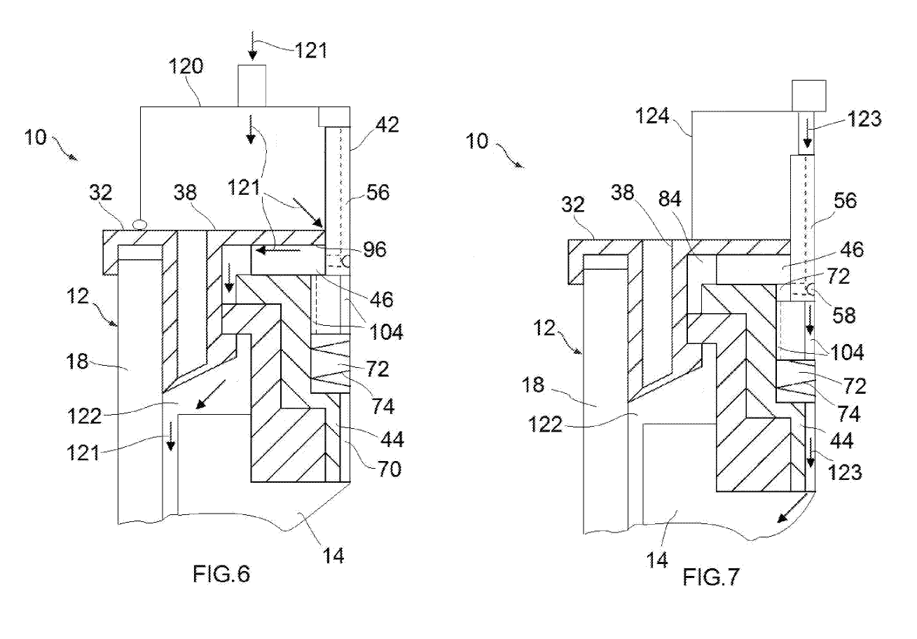

FIGS. 6 and 7 show filling of the fuel canister 10 by a filling apparatus, which is known per se and shown in schematic form.

Referring to FIG. 6, a first filling head 120 is engaged with the fuel canister 10 to block the delivery passage 56 of the valve stem 42 and deliver liquefied propellant 121 at high pressure between the valve cup 32 and valve stem 42. The pressure of the liquefied propellant 121 is sufficient to force the propellant between the valve seal 46 and the underside 96 of the top face of the boss 38 and on into the side passages 84 of the valve stem housing 44. From the side passages 84, the liquefied propellant 121 passes into the space 122 defined between the inner and outer containers 12, 14 via gaps between inner side 98 of the side face 100 of the boss 38 and the flange 114 and the spaces 118 between the protrusions 116. Subsequent to injection of the liquefied propellant, a pressure sensing system (not shown) may be used to check the pressure of the liquefied propellant in the space 122. Provided the pressure at least matches a predetermined threshold value, a suction head (not shown) may be engaged with the valve stem 42 to depress the valve stem and apply suction to clear the inner container 14 for filling with liquefied fuel.

Referring to FIG. 7, subsequent to filling of the space 122 with propellant and the optional step of clearing the inner container 14, a second filling head 124 may then be engaged with the fuel canister 10 to depress the valve stem 42 so that the radially outer ends of the side passages 58 are moved out of engagement with the valve seal 46 and into the chamber 72. Liquefied fuel 123 is then injected into the delivery passage 56 of the valve stem 42. The injected liquefied fuel 123 progresses from the delivery passage 56 into the chamber 72 via the side passages 58 and then on into the inner container 14 via the side passages 104 in the valve stem base 50 and the delivery passage 70. At this stage, the engagement of the first sealing surface 106 of the valve seal 46 with the first sealing surface 80 of the seal housing 68, engagement of the second sealing surface 110 of the valve seal with the second sealing surfaces 82 of the sealing housing 68 and engagement of the fourth sealing surface 112 of the valve seal with the side wall 60 of the valve stem 42 at least substantially ensures that the injected liquefied fuel passes into the inner container 14 and does not seep into the space 122 between the inner and outer containers 12, 14 or back between the valve stem 42 and valve cup 32.

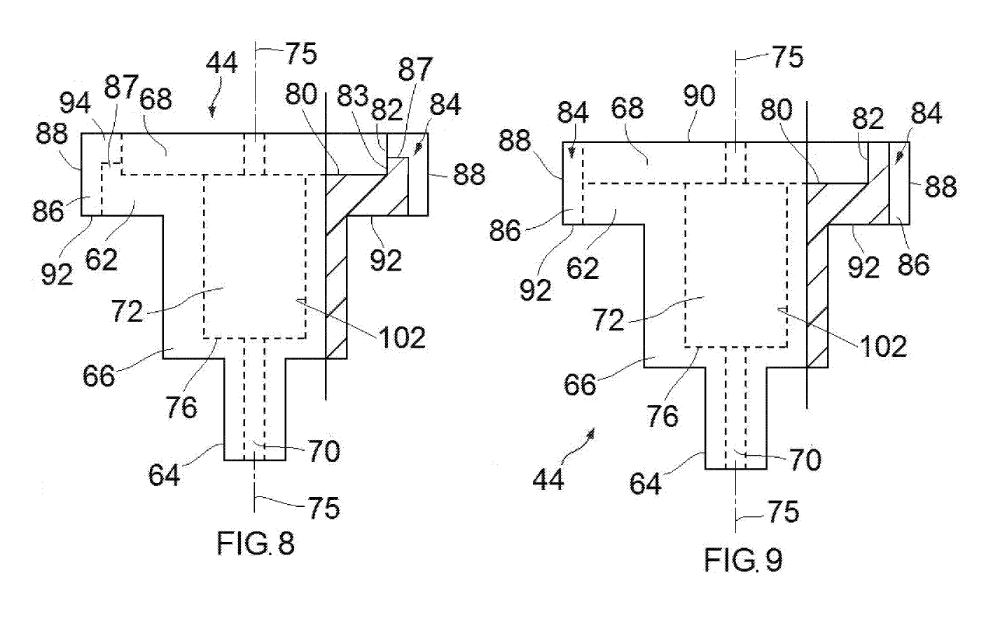

FIG. 8 shows a modification of the valve stem housing 44. In the example shown in FIG. 3, the second portion 94 of the or each side passage 84 has a height corresponding to the height of the recess that defines the seal housing 68. In the example shown in FIG. 8, the second portion 94 of the or each side passage 84 has a height that is less than the height of the seal housing 68 to leave a wall that defines a second sealing surface 82, 83 comprising an annular sealing surface portion 83 that extends continuously around the entire circumference of the first sealing surface 80. Thus, while the valve stem housing 44 shown in FIG. 3 defines four discrete second sealing surfaces 82 separated by the respective second portions 94 of the side passages 84, the valve stem housing shown in FIG. 8 defines a contiguous second sealing surface 82, 83 with an opening or openings defined by the or each side passage 84. This may reduce the likelihood of liquefied fuel forcing its way past the valve seal 46 and into the space 122 between the inner and outer containers 12, 14 during filling of the inner container 14.

FIG. 9 shows another modification of the valve stem housing 44. In this example, the side passages 84 do not have a radially extending second portion 94 as in the examples shown in FIGS. 2, 3 and 8. Instead, the or each side passage 84 comprises just a lengthways extending channel 86 defined in the outer peripheral surface 88 of the outer end portion 62 of the valve stem housing 44. The or each side passage 86 may extend from the upper end 90 of the outer end portion 62 to the lower end 92. This example has just one second sealing surface 82 with no openings, which may provide a relatively increased sealing area with the second sealing surface 110 of the valve seal 46 when compared with the valve stem housings 44 shown in FIGS. 3 and 8 and so may further reduce the likelihood of liquefied fuel forcing its way past the valve seal 46 and into the space 122 between the inner and outer containers 12, 14 during filling of the inner container 14. However, the flow path for the liquefied propellant filling of the space 122 between the inner and outer containers 12, 14 is more restricted, which may make filling of the space 122 slower or more difficult as compared with filling when using either of the valve stem housings shown in FIGS. 3, 4 and 8.

In the example illustrated by FIGS. 3, 4, 8 and 9, the valve stem housing 44 has four side passages 84. It is to be understood that this is not essential and there may be as few as one side passage or more than four side passages. In some examples, there may be two or three side passages. Although not essential, where a plurality of side passages is provided, these may be equi-spaced around the outer peripheral surface of the outer end portion of the valve stem housing.

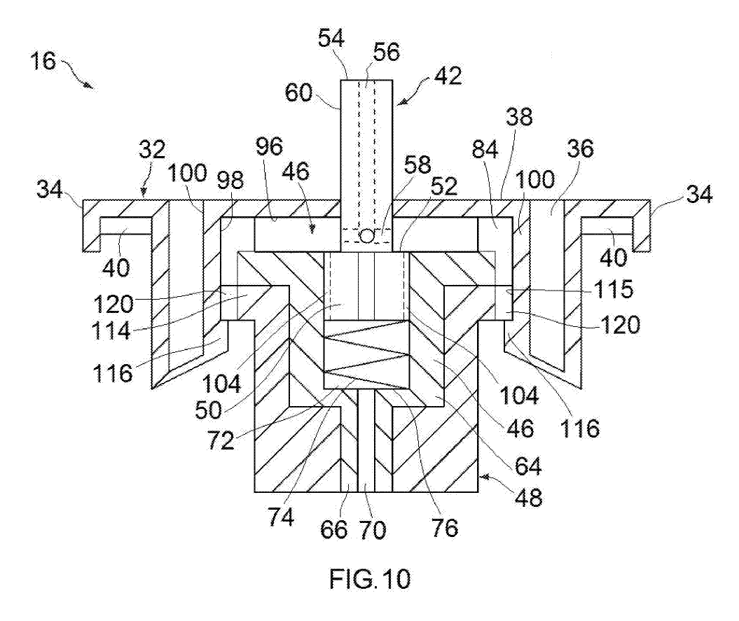

In some examples, the inner container mounting member may be provided with side passages and such side passages may be aligned with the side passages of the valve stem housing to define an at least substantially continuous side passages that have a first portion defined by a side passage of the valve stem housing and a second portion defined by a side passage of the inner container mounting member. An example of this is shown in FIG. 10, which shows a modification of the valve assembly 16 that may comprise any of the valve stem housings 44 shown in FIG. 3, 8 or 9.

In this example, the outer peripheral surface 115 of the flange 114 of the inner container mounting member 48 is provided with a plurality of side passages 120. The number of side passages 120 may correspond to the number of side passages 84. The valve stem housing 44 and inner container mounting member 48 may be configured such that the downstream ends of the side passages 84 are aligned with the upstream ends of the side passages 120 so that the side passages 84, 120 form respective portions of an at least substantially continuous side passage that defines an at least substantially continuous flow path for liquid propellant extending from the outer periphery of the seal housing 68 to the downstream ends of the side passages 120. Although not essential, preferably the downstream ends of the side passages 120 are aligned with the spaces 118 between the protrusions 116 that are produced by the crimping the valve assembly 16 to the outer container 12. It is believed that although the crimping process will leave spaces, or gaps, between the inner side 98 of the side face 100 of the boss 38 and the flange 114 of the inner container mounting member 48, these may not be sufficient to allow rapid filling of the space 122 between the inner and outer containers 12, 14. Providing one or more side passages 120 may allow speedier filling of the space 122 without substantially affecting the integrity of the joint between the valve cup 32 and the inner container mounting member 48.

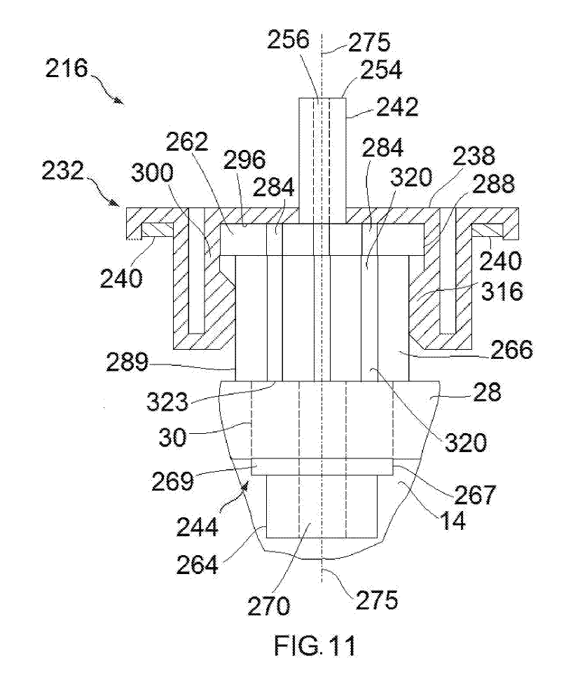

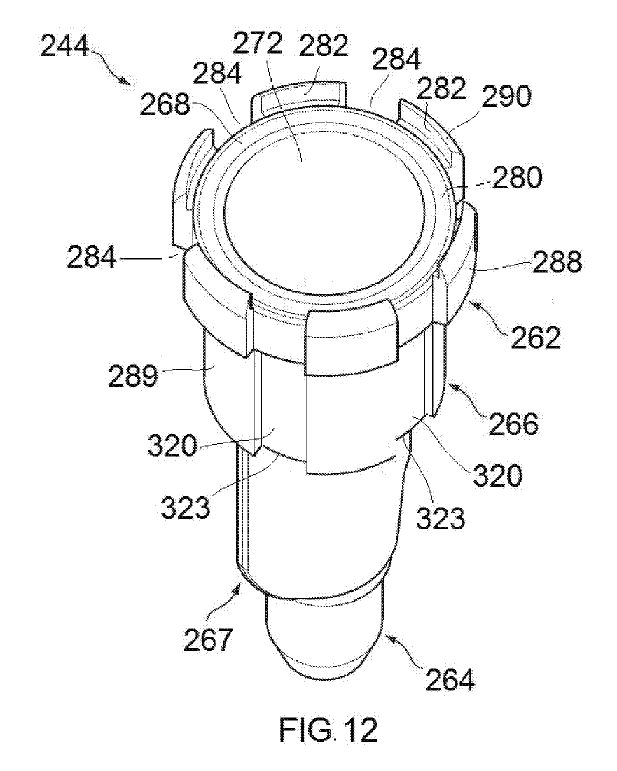

As mentioned above, although the valve assemblies 16 shown in FIGS. 2 and 10 have a separate inner container mounting members, this is not essential. Instead, the inner container 14 may be attached directly to the valve stem housing. An example of a valve assembly 216 with the inner container fitted directly to the valve stem housing will now be described with reference to FIGS. 11 and 12. For economy of presentation, in the description that follows, parts the same as or similar to parts of the valve assemblies 16 shown in FIGS. 2 to 5 and 8 to 10 will be referenced by the same reference numeral incremented by 200 and may not be described again.

Referring to FIGS. 11 and 12, the valve assembly 216 comprises a valve cup 232, a valve stem 242 and a valve stem housing 244. Although not shown, the valve assembly 216 may additionally comprise a valve seal at least substantially corresponding to the valve seal 46 described with reference to FIG. 3. In this example, there is no separate inner container mounting member and the inner container 14 is secured directly to the valve stem housing 244.

In the example shown in FIGS. 11 and 12, the valve stem housing 244 comprises a stepped generally cylindrical body that comprises an outer end portion 262, an inner end portion 264, a first intermediate portion 266 extending from the outer end portion 262 towards the inner end portion 264 and a second intermediate portion 267 extending from the inner end portion 264 towards the first intermediate portion 266. The respective widths of the portions 262-267 step down progressively from the outer end portion 262 to the inner end portion 264. Each of the portions 262-267 may be generally circular in cross-section, although, the second intermediate portion 267 may have a flattened, or oval, cross-section.

The outer end portion 262 defines a seal housing 268 (FIG. 12) to contain a valve seal (not shown) such as the valve seal 46 shown in FIGS. 2 and 3. The seal housing 268 may take the form of a generally circular recess defined in the free end of the outer end portion 262. The inner end portion 264 and second intermediate end portion 267 may define a delivery passage 270 (FIG. 11). The first intermediate portion 266 may define a space, or chamber, 272 (FIG. 12) to contain a valve stem base and a biasing member in analogous fashion to the chamber 72 shown in FIGS. 2 and 3. The seal housing 268, chamber 272 and delivery passage 270 are contiguous so as to define a through-passage extending from one end of the valve stem housing 244 to the other end that can be selectively opened and closed by axial movement of the valve stem 242.

The seal housing 268 may define a first sealing surface 280 that extends transverse to the longitudinal axis of the valve stem housing 244 and a plurality of second sealing surfaces 282 that extend transverse to the first sealing surface 280. The first sealing surface 280 may be annular and disposed at least substantially perpendicular to the longitudinal axis 275 of the valve stem housing 244. The second sealing surfaces 282 may be disposed at least substantially perpendicular to the first sealing surface 280. Although not essential, in the illustrated example there are six second sealing surfaces 282.

In this example, the second intermediate portion 267 of the valve stem housing 244 defines an integral inner container mounting member to which the inner container 14 is secured. The second intermediate portion 267 is received in the opening 30 of the inner container 14, which may be sealingly secured to the valve stem housing by a heat bonding process or a suitable adhesive. As indicated above, the second intermediate portion 267 may have a non-circular cross-section. This may facilitate fitting and securing to the relatively narrow upper end of the inner container 14 while providing a greater surface area than would be achievable with a circular section part. The second intermediate portion 267 may be provided with surface roughening or formations such as ribs configured to provide improved grip for the securing of the inner container 14.

The valve stem housing 244 may be provided with one or more side passages 284, 320. The or each side passage 284, 320 may comprise a first portion 320 defined in an outer peripheral surface 289 of the valve stem housing 244 and a second portion 284 defined in an outer peripheral surface 288 of the valve stem housing. The first and second portions 284, 320 may be generally aligned to define an at least substantially continuous side passage analogous to the side passages 84, 120 shown in FIG. 10. The or each side passage 284, 320 extends from the outer peripheral surface 288 to the outer peripheral surface 289. The or each side second portion 284 defines a gap that separates adjacent second sealing surfaces 282. The first and second portions of the or each side passage 284, 320 may comprise open channels, or grooves, defined in the outer peripheral surfaces 288, 289 and such grooves may have a generally U-shaped cross-section. The or each side passage 284, 320 may extend in the lengthways direction of the valve stem housing 244 and in some examples, may extend parallel to the longitudinal axis 275 of the valve stem housing 244. The first portion 320 of the at least one side passage 284, 320 may be narrower than the second portion 284. The first portion 320 of the at least one side passage 284, 320 may extend over the entire length of the first intermediate portion 266 of the valve stem housing 244 as shown in FIGS. 11 and 12. However, this is not essential as the first portion 320 of the at least one side passage 284, 320 may extend from the upper end of the first intermediate portion 266 to a position intermediate the ends and downstream of the protrusions 316.

In use, the valve stem housing 244 may be secured to the valve cup 232 by crimping the side face 300 of the boss 238 so as to form a series of radially inwardly extending protrusions 316 that engage and firmly grip the outer peripheral surface 289 of the first intermediate portion 266. In this way, the valve stem housing 244 is held by the protrusions 316 with a valve seal (not shown) housed in the valve seal housing 268 engaging the underside 296 of the top face of the boss 238 so that the valve seal seals between the boss 238 and the valve stem housing 244. The respective spaces (not visible in the drawing, but analogous to the spaces 118 shown in FIG. ,) defined between adjacent protrusions 316 provide gaps between the outer peripheral surface 289 of the first intermediate portion 266 and the inner side 298 of the side face 300 of the boss 238 so that during filling, liquid propellant that flows into the first portion 284 of the or each side passage 284, 320 can flow between the outer periphery of the valve stem housing 244 and the valve cup 232 to fill the space 122 between the inner and outer containers 12, 14.

The first portion 320 of the or each side passage 284, 320 facilitates the flow of liquid propellant into the space 122 between the inner and outer containers 12, 14 in analogous fashion to the side passages 120 provided on the inner container mounting member 48 of the valve assembly 16 shown in FIG. 10. It is believed that providing side passage portions 120, 320 in the parts of the outer periphery of the inner container mounting member 48 or valve stem housing 244 that engaged by the protrusions 116, 316 may provide benefits in examples in which relatively few crimps are used. This may be because when the number of crimps is relatively large, there is a correspondingly large number of spaces, or gaps, between the valve cup 32, 232 and the inner container mounting member 48 or valve stem housing 244. When a relatively a relatively smaller number of crimps is used, there will be fewer spaces, or gaps, which may result in less capacity for the flow of liquefied propellant to the space between the inner and outer containers. For example, where only four crimps are used, the percentage of the circumference of the peripheral surface of the valve stem housing or inner container mounting member that is gripped by the protrusions created, may be greater than would be covered when eight crimps are used so that the combined width of the spaces is relatively smaller so that flow of the liquefied propellant may be impeded. Also, when relatively few crimps are used there are fewer protrusions defining a correspondingly lower number of spaces, or gaps, for the liquefied propellant to flow through. This increases the likelihood that the downstream end of one or more side passages 84, 284 will be at least partially blocked by a protrusion, thus impeding the flow of liquefied propellant through the valve assembly 16, 216 to the space 122 between the inner and outer containers 12, 14. Providing side passages that extend downstream of, or otherwise bypass, the protrusions may provide an improve the flow path for the liquefied propellant that might otherwise be at least partially blocked by the protrusions, thereby potentially reducing the time required to inject the necessary amount of propellant.

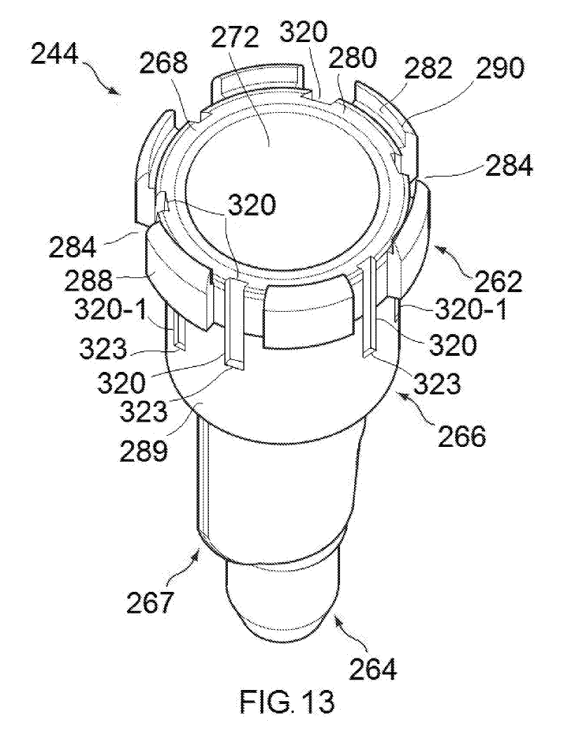

FIG. 13 shows a modification to the valve stem housing 244. The modified valve stem housing 244 can be secured to the valve cap 232 by protrusions 316 gripping the outer peripheral surface 289 of the first intermediate portion 266 in the way shown in FIG. 11.

In this example, the at least one side passage 284, 320 comprises a first portion 320 that has an upstream end disposed in the outer end portion 262 and a downstream end 323 disposed in the first intermediate portion 266 and a second portion 284 disposed in the outer end portion 262. The first portion 320 is narrower than the second portion 284 and has an upstream end disposed in the second end portion. The part of the first portion 320 that is disposed in the second portion 284 may be disposed centrally in the first portion 284 and in some examples, the respective longitudinal axes of the first and second portions 284, 320 may be aligned.

In this example, the second portion 284 of the at least one side passage 284, 320 may function as a relatively wide inlet for a relatively narrow first portion 320. While a relatively narrow side passage may be sufficient to convey the liquid propellant past the protrusions 316 it may be desirable that the or each side passage is of minimal width to provide a greater available surface area for the engagement by the protrusions, it may be advantageous for the at least one side passage 284, 320 to have a relatively wide inlet to facilitate the flow of liquid propellant past the underside 296 of the top face of the boss 238 and the valve seal and into the side passage.

Optionally, the valve stem housing 244 may be provided with one or more side passages 320-1 defined in the outer peripheral surface 289 of the first intermediate portion 266 that are not in direct flow communication with second portions 284. Instead such side passages 320-1 may channel liquid propellant that has passed through a second portion 284 and flowed around the outer peripheral surface 289. Such side passages 320-1 may assist in improving the flow of liquid propellant to the space 122 between the inner and outer containers 12, 14 in examples in which a first portion 320 of side passage 320 is blocked with manufacturing debris or crushing by overpressure applied in forming the protrusions 316.

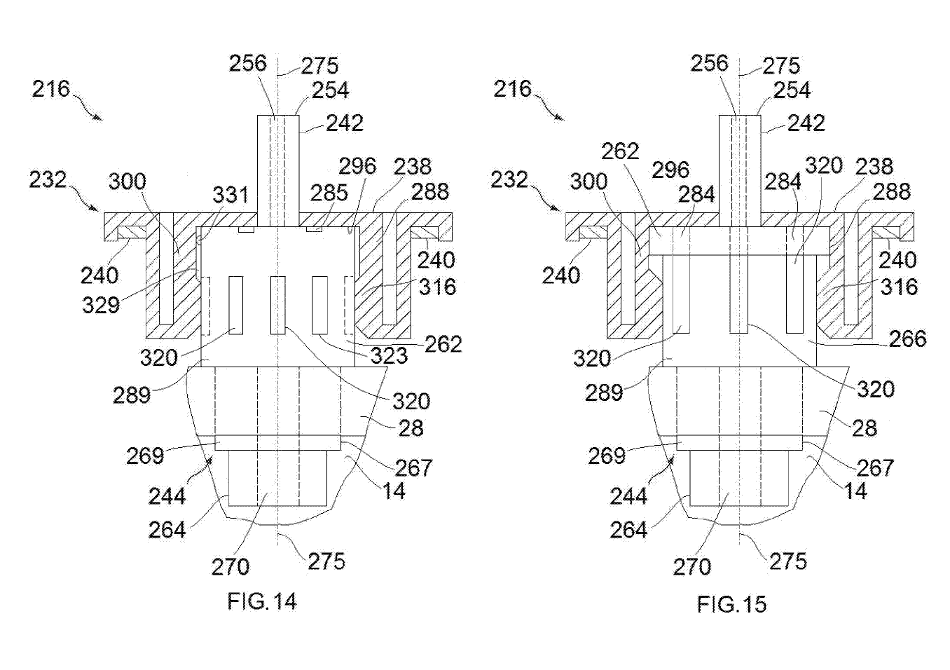

FIG. 14 shows the valve assembly 216 of FIG. 11 with another modified valve stem housing 244. In the previously described examples, the or each side passage 284, 320 has an upstream end disposed at or close to the end of the valve stem housing that engages the underside 296 of the top face of the valve cup 232 and at or adjacent the seal housing.

In this example, the at least one side passage 320 of the valve stem housing 244 is disposed remote, or spaced apart, from the underside 296 and the seal housing 268 (not shown in FIG. 14). The valve stem housing 244 is configured such that at the end that engages the underside 296 of the top face of the boss 238 there is a space 329 around the outer periphery of housing. This may be achieved by reducing the width of the outer end portion 262 as compared with the previously described examples or even having no width change so that there is no distinct first intermediate portion 266. In either case, there is a free space 329 that allows the flow of liquid propellant past the outer periphery 288 of the valve stem housing 244 to the position at which the protrusions 316 engage the valve stem housing. To assist in locating the valve stem housing 244 relative to the valve cup 232, protrusions, for example three relatively small bumps 331, may be provided on the outer periphery 288 of the valve stem housing to engage the inner side 298 of the side face 300 of the boss 238 upstream of the position at which the protrusions 316 will engage the valve stem housing. Alternatively, the underside 296 of top face of the boss 238 may be recessed to receive the end of the valve stem housing 244.

The at least one side passage 320 is arranged to extend from a position on the outer peripheral surface 288 of the valve stem housing 244 that is upstream of the position, or positions, at which the protrusions 316 will engage the valve stream housing to a position downstream of that position or positions. The downstream end 323 of the at least one side passage 320 may be at the transition to the portion 267 of the valve stem housing 244 that is engaged by the inner container 14 (for example as in the case of the at least one side passage 284, 320 shown in FIG. 12) or short of that transition as shown in FIG. 14. In either case, the at least one side passage 320 provides a flow path for liquid propellant past, or bypassing, the protrusions 316 to facilitate filling of the space 122 between the inner and outer containers 12, 14 with propellant. Optionally, the valve stem housing 244 may be provided with one or passages 333 defined in the end face of the valve stem housing 244 that engages the underside 296 of the top face of the boss 238. Such a passage, or passages, 333 may be desirable to improve the flow of liquid propellant past the seal housing 68 and the underside 296 of the top face of the boss 238 to the space 329 and may take the form of a groove or open channel.

FIG. 15 shows the valve assembly 216 of FIG. 11 with another modified valve stem housing 244. In this example, the valve stem housing 320 has at least one side passage 320 provided in the outer peripheral surface 289 of the first intermediate portion 266. The at least one side passage 320 is connected with the seal housing 268 (not shown in FIG. 15) by a passage 285. The passage 285 may extend from the first sealing surface 280 to the upstream end of the at least one side passage 320. The passage 285 forms an internal flow path within the valve stem housing 244 connecting the at least one side passage 320 with the seal housing 268. To facilitate access to the at least one passage 285, a valve seal such as the valve seal shown in FIG. 3 may be provided at least one notch in the second sealing surface 110 that is at least substantially aligned with the at least one passage 285.

It will be understood that the at least one side passage of the valve stem housings of FIGS. 10 to 15 provides a flow path for liquid propellant, at least between the protrusions that secure the valve stem housing to the valve cup and the part of the outer periphery of the valve stem housing or inner container mounting member engaged by the protrusions. In each case, the at least one side passage has an upstream end disposed at, or a first distance from, the end 290 of the valve stem housing that is disposed adjacent the underside of the top face of the valve cup 232 and a downstream end disposed a second distance from that end, which is greater than the first distance. The protrusions grip the outer periphery of the valve stem housing at one or more locations intermediate the upstream and downstream ends of the at least one side passage and are thus disposed at distances from the end 290 that are intermediate the first and second distances. In some examples, the first distance may be at least substantially zero so that the upstream end of the at least one side passage is effectively at the end 290 of the valve stem housing.

It will be understood that fuel canisters as described herein may be manufactured at one or more sites and shipped empty to a separate filling facility where they are filled with fuel and propellant.

While the invention has been illustrated and described in detail in the drawings and foregoing description, the same is to be considered as illustrative and not restrictive in character, it being understood that only the preferred embodiment has been shown and described and that all changes, equivalents, and modifications that come within the spirit of the inventions defined by following claims are desired to be protected. All publications, patents, and patent applications cited in this specification are herein incorporated by reference as if each individual publication, patent, or patent application were specifically and individually indicated to be incorporated by reference and set forth in its entirety herein.

1. A fuel canister valve assembly comprising:
a valve cup;
a valve stem housing connected with said valve cup and defining a seal housing having a first sealing surface and at least one second sealing surface extending transversely with respect to said first sealing surface;
a valve seal disposed in said seal housing and having a first sealing surface and a second sealing surface respectively engaging said first and second sealing surfaces of said seal housing; and
a valve stem having an inner end housed in said valve stem housing and extending through said valve seal to an outer end disposed externally of said valve stem housing, wherein said valve stem housing has an outer periphery provided with at least one side passage defining a flow path along said outer periphery.

2. A fuel canister valve assembly as claimed in claim 1, wherein said valve cup has a boss through which said valve stem extends and said outer periphery of the valve stem housing an inner side of a side face of said boss such that said at least one side passage defines a flow path between said outer periphery and said inner side of said side face.

3. A fuel canister valve assembly as claimed in claim 1, wherein:
said valve stem housing has a first end, and said at least one side passage has an upstream end disposed at, or a first distance from, said first end and a downstream end disposed a second distance from said first end that is greater than said first distance; and
said valve cup has a plurality of protrusions that grip said outer periphery at one or more locations intermediate and spaced from said upstream and downstream ends of said at least one side passage.

4. A fuel valve assembly as claimed in claim 3, wherein said upstream end opens into said seal housing.

5. A fuel valve assembly as claimed in claim 3, wherein:
said at least one side passage comprises a first portion that defines said downstream end and a second portion that is wider than said first portion; and
said downstream end is disposed externally of said second portion.

6. A fuel valve assembly as claimed in claim 5, wherein:
said valve stem housing comprises an outer end portion that at least partially defines said seal housing and a first outer peripheral surface of said outer periphery, an inner end portion and an intermediate portion extending from said outer end portion towards said inner end portion and defining a second outer peripheral surface of said outer periphery; and
said first portion of said at least one side passage extends from said outer end portion into said intermediate portion and said protrusions grip said outer periphery at said intermediate portion.

7. A fuel canister valve assembly as claimed in claim 3, wherein:
said valve stem housing comprises an outer end portion that at least partially defines said seal housing and a first outer peripheral surface of said outer periphery, an inner end portion and an intermediate portion extending from said outer end portion towards said inner end portion and defining a second outer peripheral surface of said outer periphery; and
said first portion of said at least one side passage is defined in said intermediate portion and said second portion of said at least one side passage is defined in said outer end portion.

8. A fuel canister valve assembly as claimed in claim 1, wherein said valve stem housing comprises an outer end portion defining an outer peripheral surface of said outer periphery and said at least one side passage comprises a channel extending between an upper end and a lower end of said outer end portion.

9. A fuel canister valve assembly as claimed in claim 6, wherein said channel defines a first portion of said at least one side passage and said at least one side passage further comprises a radially extending second portion extending from said seal housing to said channel.

10. A fuel canister valve assembly as claimed in claim 9, wherein said seal housing has a height and said radially extending second portion of said at least one side passage has a height that is less than said height of said seal housing such that said second sealing surface includes a sealing surface portion that extends continuously about said first sealing surface of said seal housing.

11. A fuel canister valve assembly as claimed in claim 8, further comprising an inner container mounting member, wherein said inner container mounting member is provided with at least one side passage, an inner end of said valve stem housing is received in said inner container mounting member and said inner container mounting member comprises at least one side passage aligned with said at least one side passage.

12. A fuel canister valve assembly as claimed in claim 1, wherein said valve seal has a third sealing surface disposed opposite said first sealing surface sealingly engaging said valve cup and a fourth sealing surface sealingly engaging said valve stem.

13. A fuel canister valve assembly comprising:
an outer container;
an inner container; and
a valve assembly,
wherein said valve assembly comprises:
a valve cup;
a valve stem housing connected with said valve cup and defining a seal housing having a first sealing surface and at least one second sealing surface extending transversely with respect to said first sealing surface;
a valve seal disposed in said seal housing and having a first sealing surface and a second sealing surface respectively engaging said first and second sealing surfaces of said seal housing; and
a valve stem having an inner end housed in said valve stem housing and extending through said valve seal to an outer end disposed externally of said valve stem housing, wherein said valve stem housing has an outer periphery provided with at least one side passage defining a flow path along said outer periphery.

14. A fuel canister comprising:
an outer container;
an inner container; and
a valve assembly to control release of a fuel from said inner container,
wherein said valve assembly comprises:
a valve cup;
a valve stem housing connected with said valve cup; and
a valve stem having an inner end housed in said valve stem housing and an outer end disposed externally of said valve stem housing, said valve stem movable inwardly of said valve stem housing to release said fuel;
wherein said valve cup is secured to said valve stem housing by a plurality of protrusions provided on said valve cup that engage said valve stem housing;
wherein said valve stem housing has an outer periphery provided with at least one side passage defining a flow path along said outer periphery;
wherein said valve stem housing has a first end and said at least one side passage has an upstream end disposed at, or a first distance from, said first end and a downstream end disposed a second distance from said first end that is greater than said first distance; and
wherein said protrusions grip said outer periphery at one or more locations intermediate and spaced from said upstream and downstream ends of said at least one side passage.

15. A fuel canister as claimed in claim 14, wherein said upstream end of said at least one side passage opens into said seal housing.

16. A fuel canister as claimed in claim 14, wherein said at least one side passage has a first portion that defines said downstream end and a second portion that is wider than said first portion and configured to channel fluid into said first portion.

17. A fuel canister as claimed in claim 16, wherein:
said valve stem housing comprises an outer end portion that at least partially defines a seal housing and a first outer peripheral surface of said outer periphery, an inner end portion and an intermediate portion extending from said outer end portion towards said inner end portion and defining a second outer peripheral surface of said outer periphery; and
said first portion of said at least one side passage extends from said outer end portion into said intermediate portion.

18. A fuel canister as claimed in claim 14, wherein:
said valve stem housing comprises an outer end portion that at least partially defines a seal housing and a first outer peripheral surface of said outer periphery, an inner end portion and an intermediate portion extending from said outer end portion towards said inner end portion and defining a second outer peripheral surface of said outer periphery; and
said first portion of said at least one side passage is defined in said intermediate portion and said second portion of said at least one side passage is defined in said outer end portion.

19. A method of filling a fuel canister that comprises an outer container, an inner container disposed in said outer container and a valve assembly secured to said inner and outer containers to control release of a fuel held in said inner container, wherein:
said valve assembly comprises a valve stem housing secured to a valve cup by protrusions on an inner side of said valve cup engaging said valve stem housing and a valve stem movable inwardly of said valve stem housing to release said fuel from said inner container; and
and said method comprises injecting liquefied propellant between said valve stem and said valve cup and channeling said injected liquefied propellant to a space defined between said inner and outer containers via a plurality of side passages provided in said valve stem housing.

20. A method of filling a fuel canister as claimed in claim 19, wherein said liquid propellant is channeled past said protrusions via said plurality of side passages.
